(19) United States
(12) Patent Application Publication
(10) Pub. No.: US 2010/0329778 A1
(43) Pub. Date: Dec. 30, 2010

(54) Metal Sheet with Reinforcement Structure

(76) Inventor: Tsong-Yow Lin, Ta Tou Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/494,413

(22) Filed: Jun. 30, 2009

(51) Int. Cl. B25G 3/20; B32B 3/04

(52) U.S. Cl. 403/367; 428/603

(57) ABSTRACT

A metal sheet comprises a main body; and numbers of reinforcement portions formed on peripheries of the main body, each reinforcement portion having an initiating terminal end coupled to the main body, a finishing terminal end extending from the initiating terminal end and two abutted portions respectively defined on two ends thereof; wherein the abutted portions of the two adjacent reinforcement portions are joined to each other.

### BACKGROUND OF THE INVENTION

1. Field of the Invention

The present invention relates to a combination of a metal sheet with a reinforcement structure and a connective block, more particularly, relates to a metal sheet including a rolled periphery as a reinforcement structure, with the rolled periphery joined with an abutted portion of a reinforcement portion adjacent to the metal sheet.

2. Description of the Related Art

Referring to Taiwan patent No. M342796, it discloses that conventional combined racks include numbers of plates and numbers of joints and each plate includes a frame and a plastic plate surface. The plastic plate surface is integrally coupled to the frame and sides of the plate surface respectively cover on outer peripheries of the frame.

The conventional combined racks consist of plastic plate surfaces and frames, although weight of each plastic plate surface is light, plastic goods have problems of weak structural strength and cannot suffer heavier items.

### SUMMARY OF THE INVENTION

The present invention is directed at providing combination of metal sheets with reinforcement structure and connective blocks. Each metal sheet is lightweight and not easy to be broken. The metal sheets with reinforcement structure includes reinforce portions which is rolled round-shaped so that the metal sheets are not easy to be bent as to achieve greater structure strength effect.

Other objectives, advantages, and features of the invention will become more apparent from the following detailed description when taken in conjunction with the accompanying drawings.

### BRIEF DESCRIPTION OF THE DRAWINGS

The present invention will be described through detailed illustration of embodiments referring to the drawings.

FIG. 1 is a perspective view of a metal sheet according to the preferred embodiment of the present invention, with the metal sheet being its primary form without any manufacture.

FIG. 2 is a perspective view of the metal sheet shown in FIG. 1, illustrating that peripheries of the metal sheet are getting to be rolled.

FIG. 3 is a perspective view of the metal sheet shown in FIG. 1, illustrating that the peripheries of the metal sheet is finished to be rolled and forms reinforcement portions.

FIG. 4 is a partial, cross-sectional view of the metal sheet with reinforcement portions shown in FIG. 3.

FIG. 5 is a front view of the metal sheet with reinforcement portions shown in FIG. 3.

FIG. 6 is a partial, enlarged view of the metal sheet with reinforcement portions shown in FIG. 5.

FIG. 7 is a cross-sectional view taken along line 7-7 in FIG. 3.

FIG. 8 is a partial, enlarged view of the metal sheet with reinforcement portions shown in FIG. 7.

FIG. 9 is a perspective view of racks which consists of the metal sheets with reinforcement portions shown in FIG. 3.

FIG. 10 is an exploded view of combination of the metal sheets with reinforcement portions shown in FIG. 3 and connective blocks according to the preferred embodiment of the present invention.

### DETAILED DESCRIPTION OF THE PREFERRED EMBODIMENT

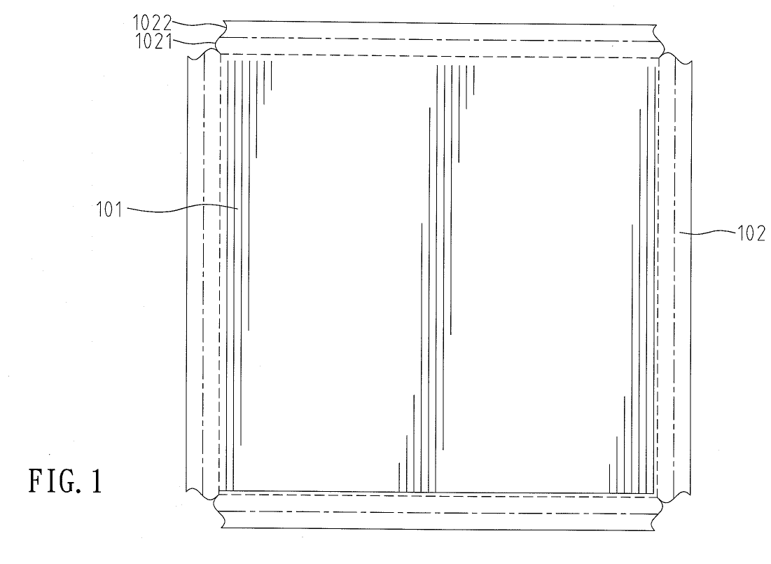

With reference to FIG. 1, it shows that a primary form of a metal sheet 1 in accordance with the preferred embodiment in the present invention. The metal sheet 1 is thin and lightweight, and is not easy to be broken. The primary form of the metal sheet 1 includes a main body 101 and four edges 102 defined on peripheries of the main body 101. Two ends of each edge 102 are preferably curve-shaped, and each edge 102 has first portion 1021 and second portion 1022 parallel to the first portion 1021. The first portion 1021 of each edge 102 is abutted against one of sides of the main body 101 and sandwiched between the related second portion 1022 and the main body 101. Ends of the first portion 1021 are protruding and ends of the related second portion 1022 are concave.

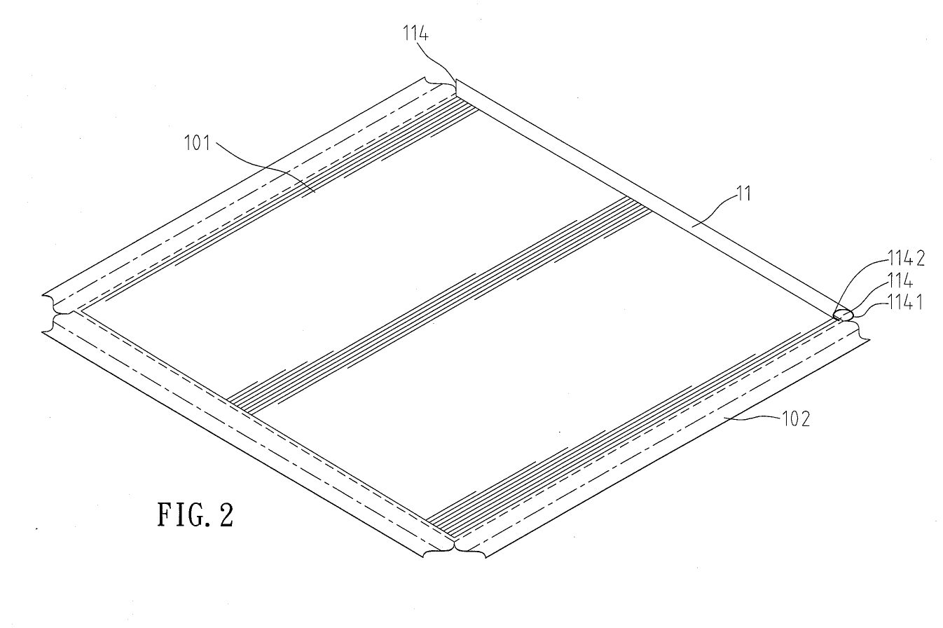

Referring to FIG. 2, it shows that process to roll the primary-form metal sheet 1 as shown in FIG. 1. One of the edges 112 forms as a reinforcement portion 11 which is rolled round-shaped and includes two abutted portions 114 defined at two ends thereof. Each abutted portion 114 has an oblique-section terminal and includes first section 1141 and second section 1142, with the first section 1141 being adjacent to the main body 101 and sandwiched between the main body 101 and the second section 1142. Distance between the first sections 1141 of the two abutted portions 114 is larger than distance between that of the second sections 1142 of the two abutted portions 114, because of contours of the first 1021 and second 1022 portions of the edge 102.

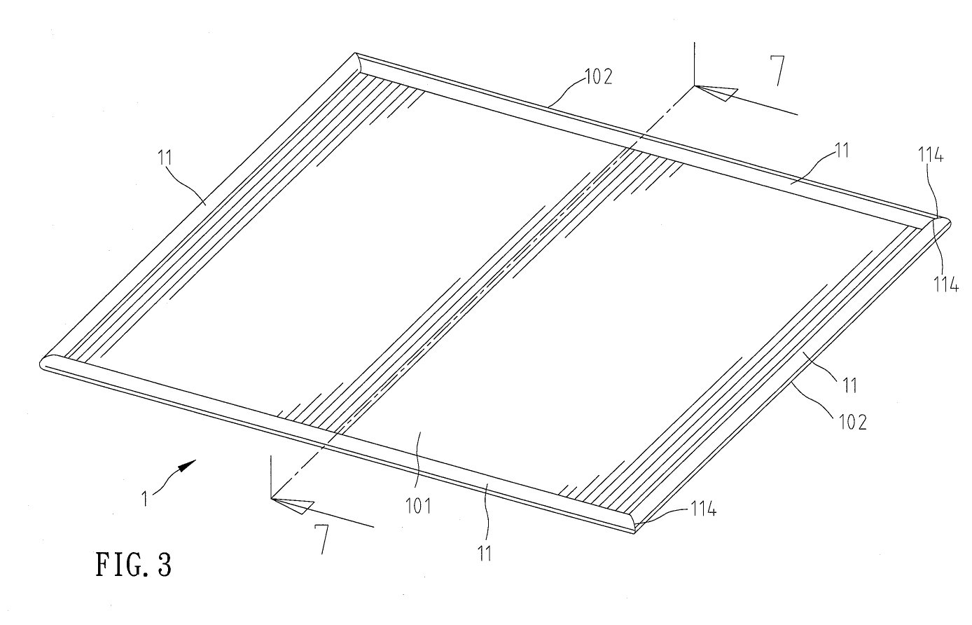

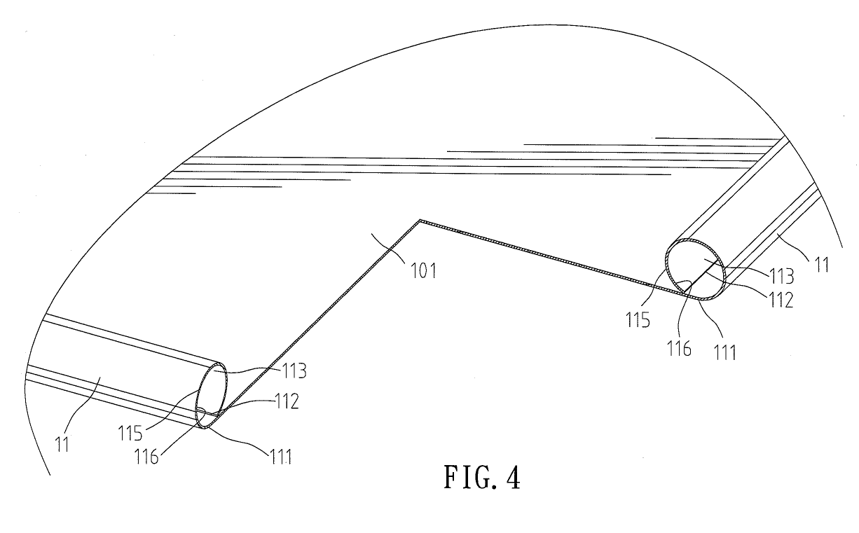

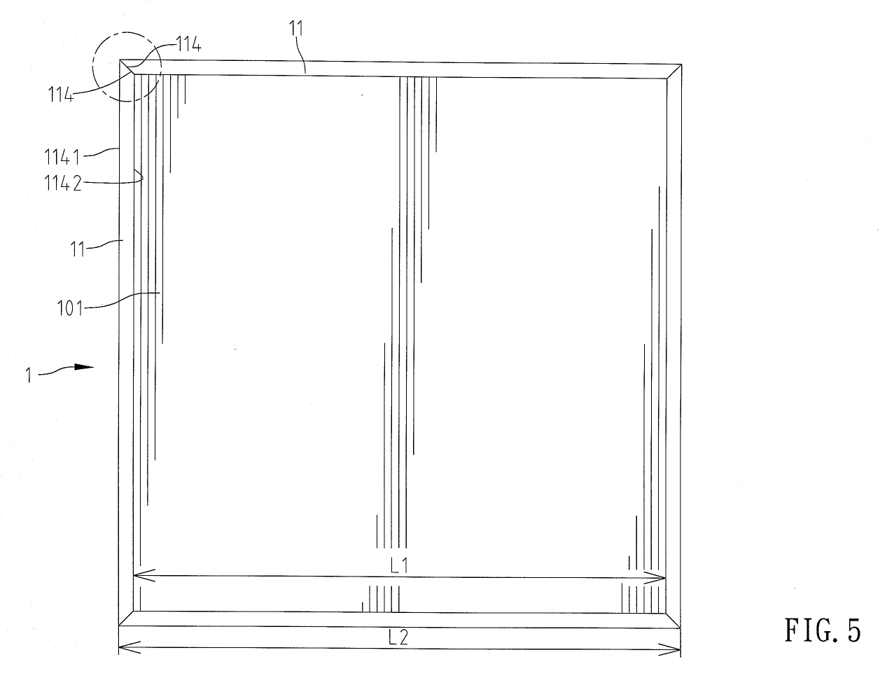

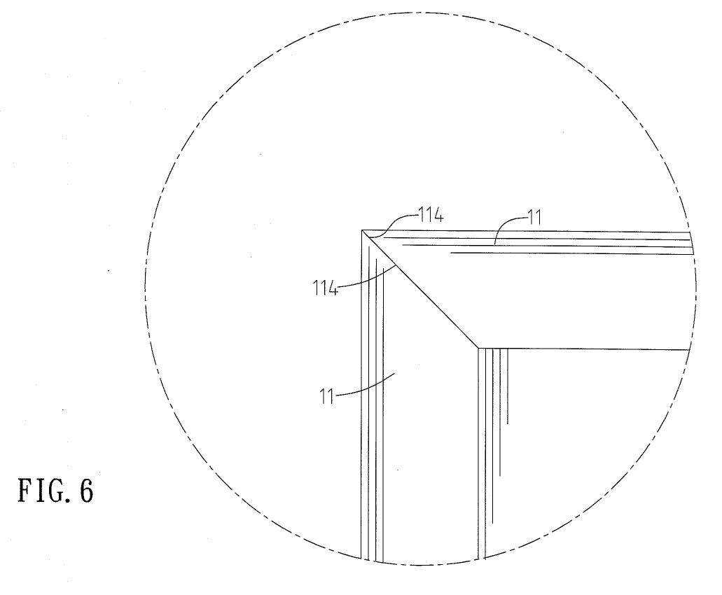

Referring to FIGS. 3 through 6, the rolled metal sheet 1 includes the main body 101 and numbers of the reinforcement portions 11 formed on peripheries of the main body 101. Each reinforcement portion 11 has an initiating terminal end 111 formed with peripheries of the main body 101 and a finishing terminal end 112 extending from the initiating terminal end 111 and rolled to form a space 113 inside of the reinforcement portion 11. The two abutted portions 114 are defined at two terminals of the reinforcement portion 11. And the abutted portions 114 of two of the adjacent reinforcement portions 11 are joined to each other.

Each reinforcement portion 11 is roll-shaped and in this case, the reinforcement portion 11 is rolled round-shaped. Each finishing terminal end 112 is preferably abutted against the initiating terminal end 111 so that the related space 103 is closed. However, a gap (not numbered) is able to be formed between each finishing terminal end 112 and the initiating terminal end 111, and an arc (not numbered) defined by the finishing terminal end 112 and the initiating terminal end 111. The size of the arc is adjustable and depended on the gap, and the arc includes an interior angle between the finishing terminal end 112 and the initiating terminal end 111. The interior angle is larger than 180 degrees. In this embodiment, range of the interior angle is preferably between 270 degrees and 360 degrees. An outer surface 115 and an inner surface 116 are respectively defined on each reinforcement portion 11, and the inner surface 116 surrounds the related space 113.

Each of the abutted portions 114 and the related periphery of the main body 101 define an included angle that is 45 degrees. And two adjacent abutted portions 114 which are joined together can offset forces which the adjacent abutted portions 114 bear respectively. In this case, each reinforcement portion 11 is in form of rolled round-shaped, and a horizontal position of each reinforcement portion 11 is higher than that of a top surface of the main body 101. Further, horizontal positions of the four reinforcement portions 11 are all higher than that of the top surface of the main body 101. The metal sheet 1 which includes the rolled round-shaped reinforcement portions 11 is not easy to be bent as to achieve greater structure strength effect.

The two adjacent abutted portions 114 are joined to each other in welding, fusion welding or adhering manner. And the second sections 1142 of the two opposite abutted portions 114 define a first distance L1, and the first sections 1141 of the two opposite abutted portions 114 define a second distance L2. In this case, the first distance L1 is smaller than the second distance L2.

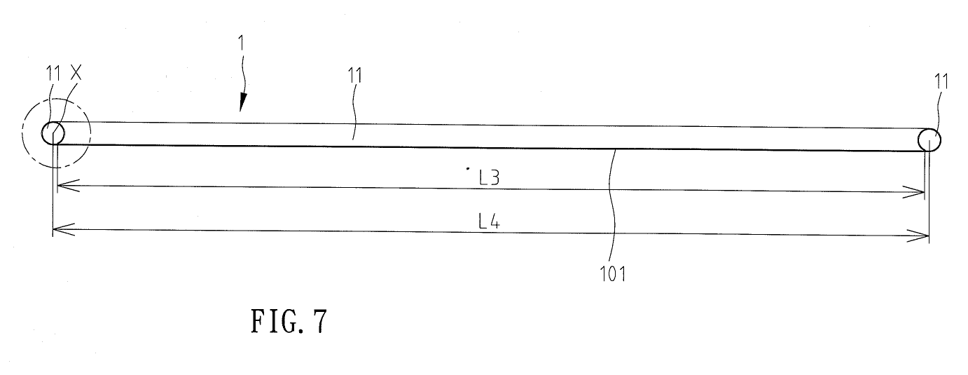

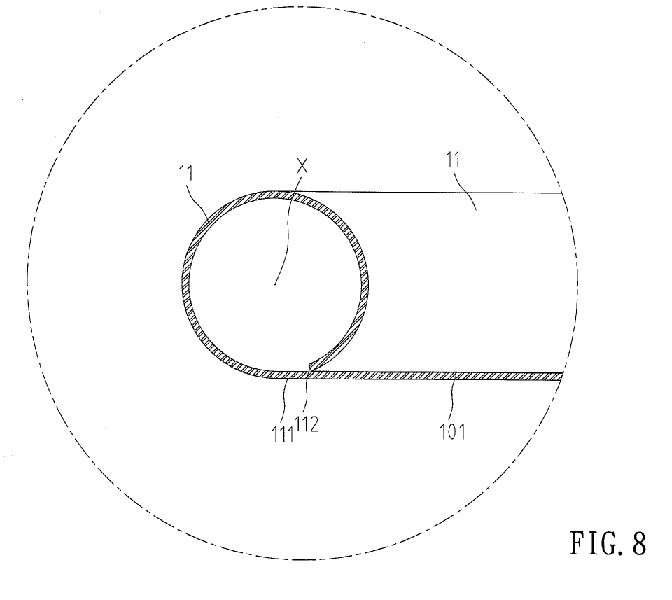

Further referring to FIGS. 7 and 8, the finishing terminal end 112 is abutted with the top surface of the main body 101. A center line X is defined by connecting center points of cross-sections of various transverse positions of each reinforcement portion 11 and provided inside of the space 13. The finishing terminal ends 112 of the two opposite reinforcement portions 11 define a third distance L3, and the center lines X of the two opposite reinforcement portions 11 define a fourth distance L4. In this case, the third distance L3 is smaller than the fourth distance L4.

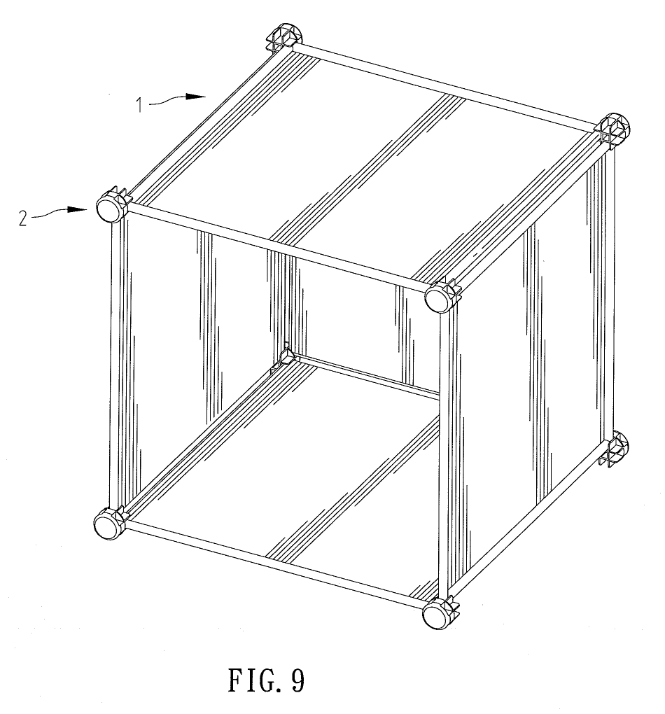

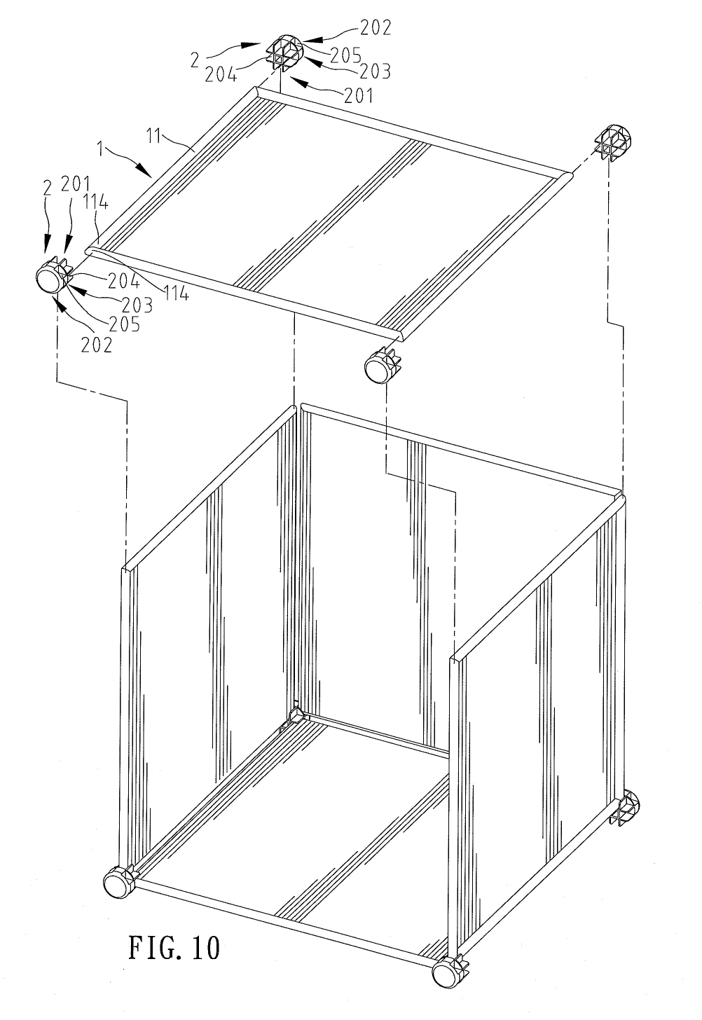

Referring to FIGS. 9 and 10, they show combined racks of metal sheets and connective blocks in accordance with the preferred embodiment of the present invention. The racks consist of numbers of the metal sheets 1 and numbers of connective blocks 2. Each connective block 2 includes first 201 and second 202 ends and a middle portion 203. The second end 202 of each connective block 2 preferably has flat surface. A plurality of first slots 204 are longitudinally formed on the first end 201 of each connective block 2 and a plurality of second slots 205 are transversely formed on the middle portion 203. And first 204 and second 205 slots are adapted to receive the abutted portions 114 of the reinforcement portions 11 of the metal sheets 1 as to join the metal sheets 1 and the connective blocks 2 together.

While several embodiments of the invention have been shown and described, it will be apparent to those skilled in the art that modifications may be made therein without departing from the scope and spirit of the present invention.

What is claimed is:

1. A metal sheet comprising:
a main body; and
numbers of reinforcement portions formed on peripheries of the main body, each reinforcement portion having an initiating terminal end coupled to the main body, a finishing terminal end extending from the initiating terminal end and two abutted portions respectively defined on two ends thereof;
wherein the abutted portions of the two adjacent reinforcement portions are joined to each other.

2. The metal sheet as claimed in claim 1 further comprising a space surrounded by an inside of each reinforcement portion; wherein a center line X is defined by connecting center points of cross-sections of various transverse positions of each reinforcement portion and provided inside of the space; wherein the finishing terminal ends of the two opposite reinforcement portions define a third distance, and the center lines X of the two opposite reinforcement portions define a fourth distance, with the third distance being smaller than the fourth distance.

3. The metal sheet as claimed in claim 1 wherein each of the abutted portions and the related periphery of the main body define an included angle that is 45 degrees.

4. The metal sheet as claimed in claim 2 wherein each of the abutted portions and the related periphery of the main body define an included angle that is 45 degrees.

5. The metal sheet as claimed in claim 1 wherein each abutted portion has an oblique-section terminal and includes first section and second section, with the first section being adjacent to the main body and sandwiched between the main body and the second section; wherein distance between the first sections of the two abutted portions is larger than distance between that of the second sections of the two abutted portions.

6. The metal sheet as claimed in claim 1 further comprising an arc defined by the finishing terminal end and the initiating terminal end of each reinforcement portion; wherein size of the arc includes an interior angle between the finishing terminal end and the initiating terminal end, with the interior angle being larger than 180 degrees; wherein each reinforcement portion is rolled round-shaped.

7. The metal sheet as claimed in claim 6, with range of the interior angle is preferably between 270 degrees and 360 degrees.

8. The metal sheet as claimed in claim 1 wherein a horizontal position of each reinforcement portion is higher than that of a top surface of the main body.

9. The metal sheet as claimed in claim 8 wherein the finishing terminal end is abutted with the top surface of the main body.

10. A combination of metal sheet with reinforcement structure and connective block, the combination comprising:
at least one of metal sheet including a main body; and numbers of reinforcement portions formed on peripheries of the main body, each reinforcement portion having an initiating terminal end coupled to the main body, a finishing terminal end extending from the initiating terminal end and two abutted portions respectively defined on two ends thereof; wherein the abutted portions of the two adjacent reinforcement portions are joined to each other; and
at least one of connective block including numbers of first slots formed on peripheries thereof and receiving the abutted portions of the reinforcement portions.

11. The combination as claimed in claim 10, wherein each connective block includes first and second ends, with the first slots formed on peripheries of the first end longitudinally.

12. The combination as claimed in claim 10, wherein each connective block defines a middle portion between the first and second ends and includes numbers of second slots formed on peripheries of the middle portion transversely and adapted to receive the abutted portions of the reinforcement portions.

13. The combination as claimed in claim 10 further comprising a space surrounded by inside of each reinforcement portion; wherein a center line X is defined by connecting center points of cross-sections of various transverse positions of each reinforcement portion and provided inside of the space; wherein the finishing terminal ends of the two opposite reinforcement portions define a third distance, and the center lines X of the two opposite reinforcement portions define a fourth distance, with the third distance being smaller than the fourth distance.

14. The combination as claimed in claim 10 wherein each of the abutted portions and the related periphery of the main body define an included angle that is 45 degrees.

15. The combination as claimed in claim 10 wherein each abutted portion includes first section and second section, with the first section being adjacent to the main body and sandwiched between the main body and the second section; wherein distance between the first sections of the two abutted portions is larger than distance between that of the second sections of the two abutted portions.

16. The combination as claimed in claim 10 further comprising an arc defined by the finishing terminal end and the initiating terminal end of each reinforcement portion; wherein size of the arc includes an interior angle between the finishing terminal end and the initiating terminal end, with the interior angle being larger than 180 degrees; wherein each reinforcement portion is rolled round-shaped.

17. The combination as claimed in claim 16, with range of the interior angle is preferably between 270 degrees and 360 degrees.

18. The combination as claimed in claim 10 wherein a horizontal position of each reinforcement portion is higher than that of a top surface of the main body.

19. The combination as claimed in claim 18, wherein the finishing terminal end is abutted with the top surface of the main body.
